(19) United States
(12) Patent Application Publication
(10) Pub. No.: US 2026/0063778 A1
(43) Pub. Date: Mar. 5, 2026

(54) Electromagnetic Wave Transmitting/Receiving Device and Method

(71) Applicant: Hitachi, Ltd., Tokyo (JP)

(72) Inventors: Makoto ITO, Tokyo (JP); Yosuke TANABE, Tokyo (JP); Tsukasa FUNANE, Tokyo (JP); Hisatoshi KIMURA, Tokyo (JP); Koichi WATANABE, Tokyo (JP)

(21) Appl. No.: 19/298,392

(22) Filed: Aug. 13, 2025

(30) Foreign Application Priority Data
Sep. 2, 2024 (JP) 2024-150610

(51) Int. Cl. G01S 13/32; G01S 7/02; H01Q 1/24; H01Q 3/36; H01Q 7/00

(52) U.S. Cl. CPC G01S 13/32; G01S 7/027; H01Q 1/24; H01Q 3/36; H01Q 7/00

(57) ABSTRACT

Provided is an electromagnetic wave transmitting/receiving device capable of transmitting OAM radio waves in at least two directions and receiving OAM radio waves arriving from at least two directions. This electromagnetic wave transmitting/receiving device includes: a plurality of antennas; a plurality of phase shifters each connected to a corresponding one of the antennas; a phase shift controller that controls phase-shifting by the phase shifters; and an antenna selector that selects an antenna to be used for transmitting or receiving electromagnetic waves from among the plurality of antennas. The antenna selector selects three or more antennas oriented in at least two different directions from among the plurality of antennas in accordance with directions in which the electromagnetic waves are transmitted or received. The phase shift controller identifies phases of the phase shifters connected to the three or more antennas selected by the antenna selector, with respect to an approximate center of the three or more antennas on the basis of the directional orientations and relative positions of the three or more antennas, and controls the phase shifters.

### CLAIM OF PRIORITY

The present application claims priority from Japanese Patent Application JP 2024-150610 filed on Sep. 2, 2024, the content of which is hereby incorporated by reference into this application.

### BACKGROUND

The present invention relates to an electromagnetic wave transmitting/receiving device and method.

In today's advanced information society, there is a constant need to increase the capacity of wireless communication systems. In order to increase communication capacity, many studies have been conducted on “expansion of radio wave bandwidth,” “increase in modulation multi-value number,” and “multiplexing of spatial transmission” using linearly polarized (horizontal or vertical polarized) or circularly polarized (right-rotating or left-rotating circularly polarized) electromagnetic waves.

Here, electromagnetic waves have two types of physical quantities called spin angular momentum (SAM) and orbital angular momentum (OAM). It is known that the SAM is related to the polarization state and that changes in polarization state concomitant with the interaction between radiation and an object can be analyzed geometrically by two orthogonal bases: horizontal polarization and vertical polarization, or right-handed circular polarization and left-handed circular polarization.

Meanwhile, in contrast to the SAM, which has only two bases, the OAM theoretically has an infinite number of bases for the rightward and leftward rotation directions and number of rotations of the helical azimuthal phase. The OAM is one of the characteristics of electromagnetic waves in which the trajectory of electromagnetic waves with the same phase is helical with respect to the direction of travel, and electromagnetic waves with the OAM can only be received by a receiver that has the same number of phase rotations as that of the transmission. In addition, the number of rotations of the helix while electromagnetic waves travels by one wavelength is referred to as an OAM mode, and electromagnetic waves with OAM modes are orthogonal to each other and do not interfere with each other. Therefore, even if electromagnetic waves with different OAM modes are combined (multiplexed), the electromagnetic waves with each OAM mode can be separated therefrom.

Because of these characteristics of OAMs, research and development of multiplex transmission technology using OAMs has been actively carried out in recent years. For example, Japanese Unexamined Patent Application Publication No. 2021-22791 discloses “a wireless communication system including: a wireless transmitter including a radio signal generator that generates radio signals and a transmission antenna unit having a plurality of transmission antenna elements that output the radio signals; and a wireless receiver including a reception antenna unit having a plurality of reception antenna elements that receive radio signals from the wireless transmitter and a radio signal processor that demodulates a transmission signal from the radio signals, in which at least one of the plurality of transmission antenna elements is configured in such a way that a polarization direction of the radio signals can be switched between a first direction and a second direction that is orthogonal to the first direction, and at least one of the plurality of reception antenna elements is configured in such a way that the polarization direction of the radio signals can be switched between a first direction and a second direction that is orthogonal to the first direction.”

### SUMMARY

Generally, for electromagnetic waves with OAM (hereinafter referred to as OAM radio waves), a uniform circular array (UCA) or loop antenna array is used as a transmitting/receiving device. Because these antennas are directional, for example, when used as antennas for data relay satellites, the antennas can transmit and receive OAM radio waves in a specific direction, but cannot transmit and receive OAM radio waves in parallel in all directions (at least two or more directions).

The present invention has been made in view of this problem, and an object of the present invention is to provide a transmitting/receiving device capable of transmitting and receiving OAM radio waves in parallel in at least two or more directions.

The present invention includes a plurality of solutions to at least part of the above problem, and examples thereof are as follows. That is, an electromagnetic wave transmitting/receiving device including: a plurality of antennas; a plurality of phase shifters each connected to a corresponding one of the plurality of antennas; a phase shift controller that controls phase-shifting by the plurality of phase shifters; and an antenna selector that selects an antenna to be used for transmitting or receiving electromagnetic waves from among the plurality of antennas. The antenna selector selects three or more antennas oriented in at least two different directions from among the plurality of antennas in accordance with directions in which the electromagnetic waves are transmitted or received. The phase shift controller controls the plurality of phase shifters connected to the three or more antennas selected by the antenna selector, with respect to an approximate center of the three or more antennas on the basis of directional orientations and relative positions of the three or more antennas, so that the electromagnetic waves transmitted or received from the three or more antennas become OAM radio waves.

According to the present invention, it is possible to transmit OAM radio waves to all directions and to receive OAM radio waves arriving from all directions.

Problems, configurations and effects other than those described above will be clarified in the following description of embodiments.

### BRIEF DESCRIPTION OF THE DRAWINGS

FIG. 1A illustrates a bird's-eye view of an example of the configuration of a transmitting/receiving device according to a first embodiment;

FIG. 1B illustrates a front view of an example of the configuration of the transmitting/receiving device according to the first embodiment;

FIG. 1C illustrates a side view of an example of the configuration of the transmitting/receiving device according to the first embodiment;

FIG. 2 is a block diagram illustrating an example of the configuration of a control device according to the first embodiment;

FIG. 3 illustrates an example of signal transmission processing steps executed by the control device according to the first embodiment;

FIG. 4 illustrates an example of signal reception processing steps executed by the control device according to the first embodiment;

FIG. 5 is a conceptual diagram illustrating examples of utilization of the transmitting/receiving device according to the first embodiment;

FIG. 6A illustrates a bird's-eye view of an example of the configuration of a transmitting/receiving device according to a second embodiment;

FIG. 6B illustrates a front view of an example of the configuration of the transmitting/receiving device according to the second embodiment;

FIG. 6C illustrates a side view of an example of the configuration of the transmitting/receiving device according to the second embodiment;

FIG. 7A illustrates a bird's-eye view of a modification of the configuration of the transmitting/receiving device according to the second embodiment;

FIG. 7B illustrates a front view of the modification of the configuration of the transmitting/receiving device according to the second embodiment;

FIG. 7C illustrates a side view of the modification of the configuration of the transmitting/receiving device according to the second embodiment;

FIG. 8A illustrates an example of the configuration of one thin film according to the second embodiment;

FIG. 8B illustrates another example of the configuration of one thin film according to the second embodiment;

FIG. 9A illustrates a bird's-eye view of an example of the configuration of a transmitting/receiving device according to a third embodiment; and

FIG. 9B illustrates an example of a loop antenna array formed by tension members on one face of an icosahedron according to the third embodiment.

### DETAILED DESCRIPTION

Hereinafter, embodiments of the present invention will be described with reference to the accompanying drawings. Embodiments are examples for explaining the present invention and are omitted and simplified as appropriate for clarity of explanation. The present invention can also be implemented in various other forms. Unless otherwise specified, each component may be singular or plural.

The position, size, shape, range, and the like of each component illustrated in the drawings may not represent the actual position, size, shape, range, and the like in order to facilitate understanding of the present invention. Therefore, the present invention is not necessarily limited to the position, size, shape, range, and the like disclosed in the drawings. In cases where there are a plurality of components having the same or similar functions, the components may be described by adding different subscripts to the same reference numeral. In addition, if it is not necessary to distinguish between the plurality of components, the subscripts may be omitted in the description.

In the embodiments, processing performed by executing a program may be described. Here, a computer executes a program using a processor (for example, a CPU or a GPU), and performs processing defined by the program while using storage resources (for example, memory), interface devices (for example, communication ports), and the like. Therefore, the entity that carries out the processing by executing the program may be a processor. Similarly, the entity that carries out the processing by executing the program may be a controller, device, system, computer, or node having a processor.

The entity that carries out the processing by executing the program needs only to be a calculation unit, which may include a dedicated circuit for specific processing. Here, examples of the dedicated circuit include a Field Programmable Gate Array (FPGA), an Application Specific Integrated Circuit (ASIC), a Complex Programmable Logic Device (CPLD), and the like.

The program may be installed on the computer from a program source. The program source may be, for example, a program distribution server or a computer-readable storage medium. If the program source is a program distribution server, the program distribution server may include a processor and a storage resource that stores a program to be distributed, and the processor of the program distribution server may distribute the program to be distributed to other computers. In addition, in the embodiment, two or more programs may be implemented as one program, or one program may be implemented as two or more programs.

### First Embodiment

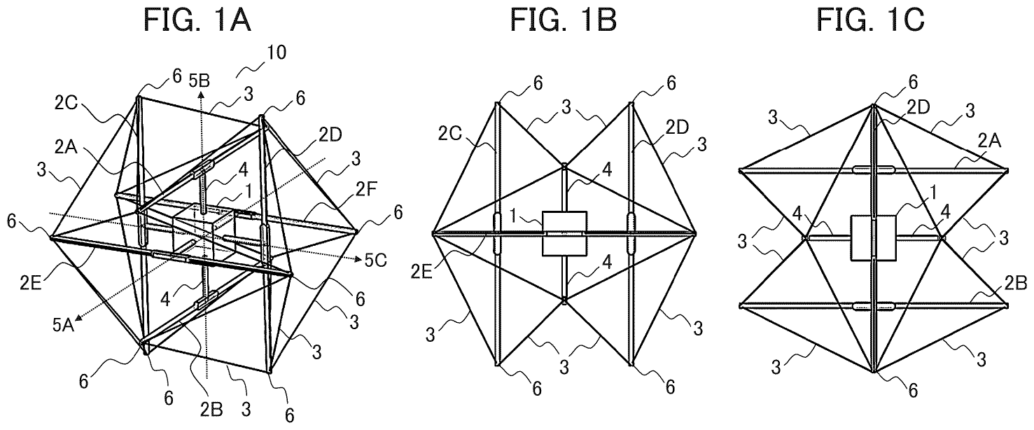

FIG. 1 illustrates an example of the configuration of an electromagnetic wave transmitting/receiving device according to a first embodiment, specifically an OAM radio wave transmitting/receiving device. FIGS. 1A, 1B, and 1C illustrate a bird's-eye view, front view, and side view, respectively. In the present embodiment, the transmitting/receiving device is configured as a virtual regular polyhedron constructed with the approximate center of the transmitting/receiving device as the origin. As an example of this, in the present embodiment, the transmitting/receiving device is a virtual regular icosahedron. Note that although the term “regular polyhedron” is used in the following description, it is sufficient if it is a polyhedron, and does not necessarily have to be “regular” in the strict sense.

In FIG. 1, a transmitting/receiving device 10 includes a control device 1 located approximately in the center of the transmitting/receiving device 10, a plurality of compression members 2, a plurality of tension members 3, and a plurality of poles 4 connecting the control device 1 and each compression member 2, and forms a virtual regular icosahedral three-dimensional structure around the control device 1 using the compression members 2 and the tension members 3. The control device 1, which is located approximately in the center of the transmitting/receiving device 10 in FIG. 1, is generally cubic in shape in the present embodiment. In addition, although there are a plurality of rotational symmetry axes of the regular icosahedron formed around the control device 1, in the present embodiment, the three orthogonal axes from the approximate center of the regular icosahedron toward each face of the control device 1, which is cubic in shape, are defined as rotational symmetry axes 5 (5A, 5B, and 5C).

There are a total of six compression members 2, namely, compression members 2A, 2B, 2C, 2D, 2E, and 2F, and the compression members 2 are rod-shaped (prismatic or cylindrical) and have the same length. The compression members 2, two for each of the rotational symmetry axes 5, are arranged equidistant from the rotational symmetry axis 5 with the rotational symmetry axis 5 sandwiched therebetween, and parallel to the rotational symmetry axis 5. With this arrangement, the compression members 2 are each positioned so that its approximate center portion is orthogonal to one of the rotational symmetry axes 5A, 5B, and 5C, and are spaced approximately equidistant from each face of the control device 1. For example, in FIG. 1, the compression members 2A and 2B are arranged above and below, respectively, with the rotational symmetry axis 5A and the control device 1 sandwiched therebetween, the compression members 2C and 2D are arranged on the left and right sides, respectively, with the rotational symmetry axis 5B and the control device 1, and the compression members 2E and 2F are arranged at the front and at the rear, respectively, with the rotational symmetry axis 5C and the control device 1. Each of the tension members 3 connects two nearest ends 6 among the total of twelve ends 6 of the compression members 2. Thus, the ends 6 of each of the compression members 2 are each simultaneously supported by the four tension members 3. A compressive force in the direction orthogonal to the rotational symmetry axis 5A, 5B, or 5C act on each of the compression members 2, along with the tension exerted by the four tension members 3. In this manner, the compression members 2 and the tension members 3 are arranged so that the compression force acting on the compression members 2 and the tension force by the tension members 3 are balanced, thereby forming an icosahedron with a tensegrity structure around the control device 1. Note that this shape is generally similar to a three-dimensional shape called Jessen's icosahedron.

In the transmitting/receiving device 10, each of the compression members 2 serves as a dipole antenna. Therefore, examples of materials used as the compression members 2 include beryllium copper, carbon fiber reinforced plastics (CFRP) combined with copper, and the like. Meanwhile, examples of the tension members 3 include high-strength nylon strings such as those made of polyethylene, CFRP, stainless steel wire, copper wire, thin films, and the like. Since the poles 4 each function as wiring connecting the control device 1 and the compression member 2, examples of the poles 4 include beryllium copper and stainless steel, and the like. Note that the transmitting/receiving device 10 may be a structure that maintains the regular icosahedral shape described above, or may be a deployable structure that can be folded when not in use and deployed into the above shape when in use.

With the above configuration, the various directional orientations and relative positional relationships of the dipole antennas by the compression members 2 enable the transmitting/receiving device 10 to transmit and receive OAM radio waves in at least two directions without the need to rotate the device itself, or the like.

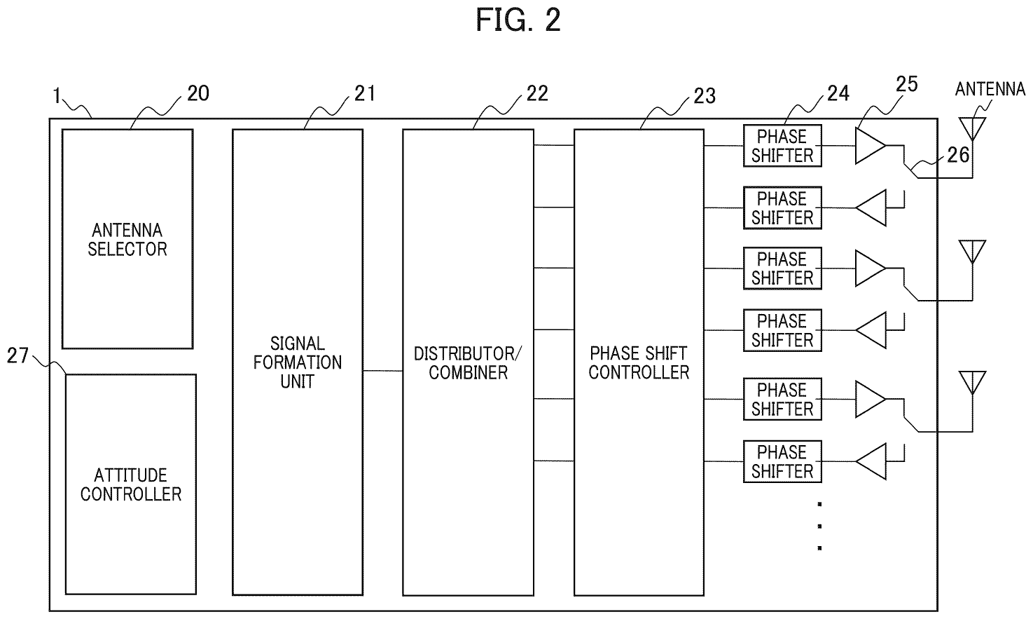

FIG. 2 is a block diagram illustrating an example of the internal configuration of the control device 1. In FIG. 2, the control device 1 includes an antenna selector 20, a signal formation unit 21, a distributor/combiner 22, a phase shift controller 23, a plurality of phase shifters 24, a plurality of amplifiers 25, a plurality of switches 26, and an attitude controller 27. The antenna selector 20 selects an antenna (in the example in FIG. 1, one of the dipole antennas (compression members 2)) to be used for transmitting signals (OAM radio waves), as described below. The signal formation unit 21 generates a signal to be transmitted from the transmitting/receiving device 10. When transmitting a signal, the distributor/combiner 22 receives the signal generated by the signal formation unit 21 and distributes the signal according to the number of antennas used for signal transmission. When receiving a signal, the distributor/combiner 22 combines the signals received by the plurality of antennas into a single signal. For example, in the present embodiment, there are a total of six compression members 2 that serve as dipole antennas, but if three of the compression members 2 are used for signal transmission, the distributor/combiner 22 divides the signal into three for output during signal transmission. Meanwhile, during signal reception, the distributor/combiner 22 combines a plurality of signals received by several of the six dipole antennas into a single signal.

The phase shift controller 23 calculates the phase of each signal distributed by the distributor/combiner 22 or received by the plurality of antennas, and instructs each phase shifter, which is connected to the antenna used for signal transmission or the antenna receiving the signal, to set the calculated phase. Two phase shifters 24 are provided for each antenna, one for signal transmission and one for signal reception, and each of the phase shifters 24 changes the phase of the signal to be transmitted or the signal that has been received, in accordance with the phase instructed by the phase shift controller 23. The amplifier 25 for signal amplification is connected to each phase shifter 24, and the two phase shifters 24 provided for each antenna, one for signal transmission and one for signal reception, are connected to the antenna via the switch 26 for switching the connection between the amplifier 25 and the antenna. The attitude controller 27 adjusts the attitude (orientation or the like) of the entire transmitting/receiving device 10 during signal transmission or signal reception, as described below.

Note that although FIG. 2 illustrates an example in which the control device 1 is equipped with the distributor/combiner 22, for example, the signal formation unit 21 may be equipped with a function similar to the distributor/combiner 22, that is, to distribute signals according to the number of selected antennas or to combine signals received by the plurality of antennas. Alternatively, instead of distributing the generated signal, the signal formation unit 21 may generate a signal to be transmitted for each antenna. In addition, FIG. 2 illustrates two phase shifters for each antenna, one for transmission and one for reception, for example. However, for example, one phase shifter may be provided for each antenna, and the phase shifter may be shared between transmission and reception.

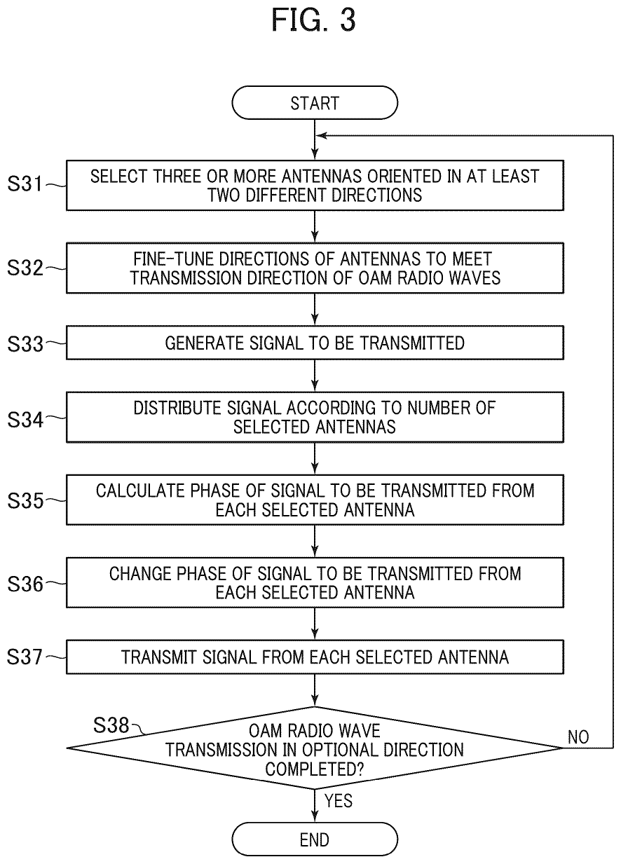

FIG. 3 illustrates an example of signal transmission processing steps executed by the control device 1. As described above, the transmitting/receiving device 10 transmits and receives signals (OAM radio waves). OAM is one of the characteristics of electromagnetic waves in which the trajectory of radio waves with the same phase forms a helix with respect to the direction of travel, and the number of rotations of the helix while the electromagnetic waves travel by one wavelength is referred to as an OAM mode. For example, if the number of rotations of the helix while the electromagnetic waves travel by one wavelength is one rotation, this is OAM mode 1. To generate such helical OAM mode 1 electromagnetic waves, it is necessary to transmit electromagnetic waves from at least three antennas that are oriented in at least two different directions. In this case, the signals transmitted from the antennas are, for example, linearly or circularly polarized signals, but the phases of the signals are controlled so as to rotate with respect to the approximate center of at least three antennas on the basis of the directional orientations and relative positions of the antennas, so that these signals are combined in space to form an OAM mode 1 radio wave. Note that regarding the approximate center of at least three antennas above, the center of a virtual sphere or circle formed by an array antenna composed of a plurality of selected antennas is referred to as the approximate center here, and the center includes the center of gravity, outer center, and inner center.

In S31 in FIG. 3, the antenna selector 20 of the control device 1 selects at least three antennas oriented in at least two different directions from among the plurality of antennas (in the example in FIG. 1, six dipole antennas (compression members 2)) of the transmitting/receiving device 10, in accordance with the direction in which OAM radio waves are transmitted and OAM mode. Note that as described above, by changing the antennas selected by the antenna selector 20 in accordance with the direction in which OAM radio waves are transmitted, the transmitting/receiving device 10 is capable of transmitting OAM radio waves in at least two directions.

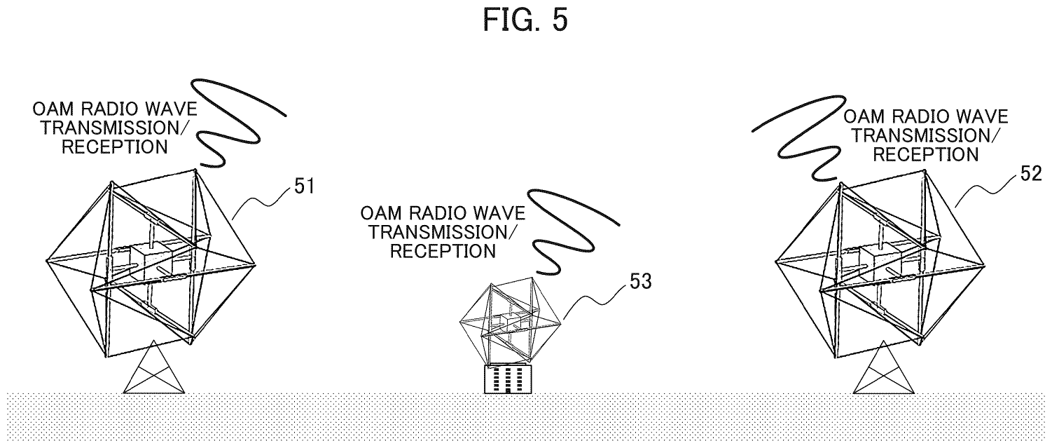

In S32 in FIG. 3, the attitude controller 27 of the control device 1 controls the attitude of the transmitting/receiving device 10, and fine-tunes the directions of the antennas selected in S31, with respect to the direction in which OAM radio waves are transmitted. Here, examples of utilization of the transmitting/receiving device 10 illustrated in FIG. 1 will be described. FIG. 5 is a conceptual diagram illustrating examples of utilization of the transmitting/receiving device 10. In FIG. 5, the transmitting/receiving device 10 are installed, for example, in base stations 51 and 52, on the roof of a building 53 such as a data center, or the like to transmit and receive OAM radio waves to each other for data communication. OAM radio waves are desirably received by a receiving device that has the same number of phase rotations as that of the transmission, and the receiving device can receive OAM radio waves by receiving signals using the same number of antennas as the number of antennas through which a transmitting device transmits the signals. In addition, because antennas have directivity, the transmitting direction of each antenna at the transmitting device and the receiving direction of each antenna at the receiving device need to be as consistent as possible. Therefore, in order to enable the transmitting/receiving device on the receiving side to receive OAM radio waves, the control device 1 fine-tunes the direction of each antenna selected by the attitude controller 27 to match the receiving direction of the transmitting/receiving device on the receiving side. Note that as illustrated in FIG. 5, if the transmitting/receiving device 10 is fixedly installed in a base station or building, adjustment of the antenna direction with respect to the transmitting/receiving device on the receiving side may not always be necessary, but if, for example, the transmitting/receiving device 10 is mounted on a mobile unit (such as a data relay satellite), it is necessary for the attitude controller 27 to control the attitude of the transmitting/receiving device 10 and adjust the antenna direction. If the transmitting/receiving device 10 is mounted on a spacecraft, the attitude controller 27 may be a reaction wheel, a magnetic torquer, a thruster, or the like.

In S33 in FIG. 3, the signal formation unit 21 of the control device 1 generates a signal to be transmitted. Signals generated by the signal formation unit 21 are general signals such as sine or cosine waves. In S34, the distributor/combiner 22 distributes the generated signal into signals corresponding to the number of selected antennas. As described above, for example, if three dipole antennas (compression members 2) are used in the transmitting/receiving device 10, the distributor/combiner 22 divides the generated signal into three for output. In S35, to ensure that the signals transmitted from the antennas become OAM radio waves in space, the phase shift controller 23 calculates the phases of the signals to be transmitted from the antennas, such that the signals transmitted from the antennas rotate with respect to the approximate center of the plurality of selected antennas, on the basis of the directional orientations and relative positions of the antennas, and instructs the phase shifters 24 connected to the selected antennas to set the calculated phases. In S36, the phase shifters 24 connected to the selected antennas change the phases of the signals to be transmitted, in accordance with the phases instructed by the phase shift controller 23. Each of the phase shifters 24 for signal transmission is connected to the corresponding antenna via the amplifier 25 and the switch 26, and the phase-shifted signals are transmitted to the selected antennas, which transmit the signals at S37. Note that upon completion of OAM radio wave transmission in an optional direction in a series of signal transmission processing steps, the control device 1 terminates the signal transmission processing at S38. If an error or the like occurs, the control device 1 returns to S31 and repeats the signal transmission processing.

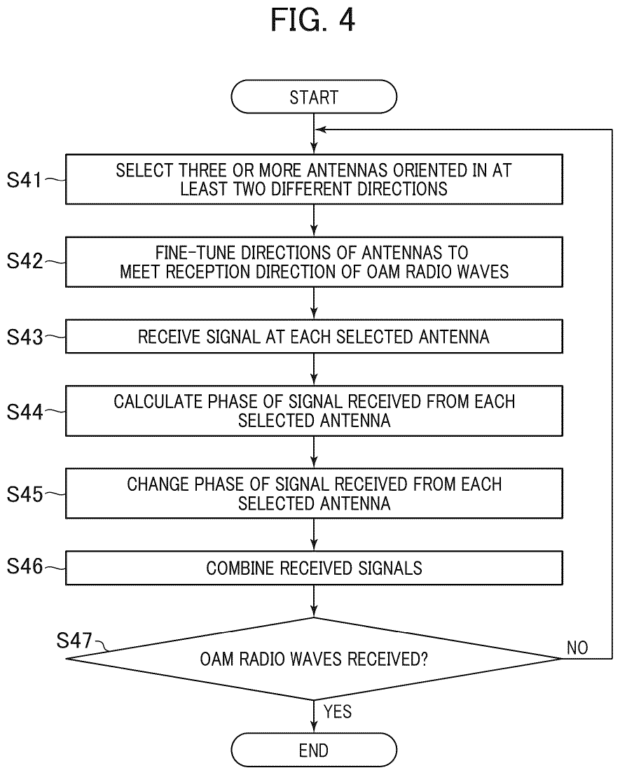

FIG. 4 illustrates an example of signal reception processing steps executed by the control device 1. In FIG. 4, at S41, similar to S31 in FIG. 3, in preparation for receiving OAM radio waves, the antenna selector 20 selects at least three antennas oriented in at least two different directions from among the plurality of antennas (in the example in FIG. 1, six dipole antennas (compression members 2)) of the transmitting/receiving device 10, in accordance with the direction in which OAM radio waves are received and the OAM mode. Note that as described above, by changing the antennas selected by the antenna selector 20 in accordance with the direction in which OAM radio waves are received, the transmitting/receiving device 10 is capable of receiving OAM radio waves from all directions. In S42, similar to S32 in FIG. 3, the attitude controller 27 controls the attitude of the transmitting/receiving device 10, and fine-tunes the direction of each antenna selected in S41, with respect to the direction in which OAM radio waves are received, that is, to match the transmitting direction of the transmitting/receiving device on the transmitting side. Note that as illustrated in FIG. 5, if the transmitting/receiving device 10 is fixedly installed in a base station, building, or the like, adjustment of the antenna direction with respect to the transmitting/receiving device on the transmitting side may not always be necessary, but if, for example, the transmitting/receiving device 10 is mounted on a mobile unit (such as a data relay satellite), it is necessary for the attitude controller 27 to control the attitude of the transmitting/receiving device 10 and adjust the antenna direction.

In S43, each selected antenna receives a signal. Each of the phase shifters 24 for signal reception is connected to the corresponding antenna via the amplifier 25 and the switch 26, and the signal received by each selected antenna is transmitted to the corresponding phase shifter 24. In S44, to ensure that the signals received by the selected antennas become correct signals in the OAM radio waves, the phase shift controller 23 calculates the phases of the signals received by the selected antennas, such that the signals received by the antennas rotate with respect to the approximate center of the plurality of selected antennas, on the basis of the directional orientations and relative positions of the antennas, and instructs the phase shifters 24 connected to the selected antennas to set the calculated phases. In S45, the phase shifters 24 connected to the selected antennas change the phases of the received signal, in accordance with the phases instructed by the phase shift controller 23. In S46, the distributor/combiner 22 combines the signals phase-shifted by the phase shifters 24. In S47, upon confirming that the signal combined by the distributor/combiner 22 is in the form of an OAM radio wave, the control device 1 terminates the signal reception processing, and if the signal is not in the form of an OAM radio wave, the control device 1 returns to S41 and repeats the signal transmission processing.

In S35 in FIGS. 3 and S44 in FIG. 4 described above, the phase shift controller 23 calculates the phase Pin of the signal to be transmitted from each selected antenna or the signal that has been received by each selected antenna, using the following Equation 1.

$${∅}_{ln} = \frac{2 π ln}{N} + {θ}_{\vert ln} \qquad ( Equation 1 )$$

In Equation 1, l is a variable representing the OAM mode, for example, l=1 for OAM mode 1. N is the number of selected antennas; for example, N=3 if three dipole antennas are selected in the example in FIG. 1. n is a number to identify each selected antenna and is assigned to each antenna each time it is selected. For example, if the compression members 2A, 2D, and 2E are selected as the three dipole antennas in the example in FIGS. 1, n=1, 2, and 3 are assigned to the compression members 2A, 2D, and 2E, respectively. Note that the order in which the antennas are assigned numbers is arbitrary. θₗₙ is the phase that depends on the directional orientation of each selected antenna and its position relative to the other antennas. θₗₙ is predetermined and stored in a memory or the like (not illustrated) in the control device 1.

Note that each time an antenna is selected, the phase shift controller 23 may calculate the phase Pin of the signal to be transmitted from each selected antenna or the signal received by each selected antenna using Equation 1, or may store the phase Pin calculated by Equation 1 in advance in a memory or the like (not illustrated) in the control device 1, and each time an antenna is selected, the phase Pin corresponding to each antenna may be read from the memory or the like and provide instructions to each phase shifter 24. In this case, in S35 in FIGS. 3 and S44 in FIG. 4, the phase shift controller 23 identifies the phase Pin corresponding to each selected antenna and reads it from the memory or the like.

In the above description of the transmission and reception processing steps illustrated in FIGS. 3 and 4, a series of processing details when the transmitting/receiving device 10 transmits and receives OAM radio waves to or from a specific direction has been explained. The transmitting/receiving device 10, with the configuration (icosahedron with a tensegrity structure) illustrated in FIG. 1, can transmit and receive OAM radio waves in parallel to or from two or more different directions. In this case, the control device 1 selects at least two sets of at least three antennas oriented in at least two different directions, in accordance with the direction in which the OAM radio waves are transmitted or received, and, for each set of antennas, executes the transmission and reception processing steps illustrated in FIG. 3 or 4 in parallel.

As described above, the transmitting/receiving device according to the first embodiment includes an icosahedron configuration with a tensegrity structure, where the compression members, serving as antennas, are arranged in various directions and positions, so that OAM radio waves can be transmitted and received in at least two directions by changing the antenna to be selected in accordance with the transmitting/receiving direction, without the need to rotate the device itself. In addition, the transmitting/receiving device according to the first embodiment is capable of correctly transmitting and receiving OAM radio waves by changing the phase of the signal to be transmitted from the plurality of antennas selected in accordance with the OAM mode or the signal that has been received by the selected antennas, to an appropriate phase according to the OAM mode, direction, and position.

### Second Embodiment

The first embodiment has illustrated an example in which by supporting the ends 6 of each compression member 2, which is a component of the transmitting/receiving device 10, using the plurality of tension members 3, the compression force acting on the compression members 2 and the tension force by the tension members 3 are balanced to form an icosahedron with a tensegrity structure, but as the tension members, not only nylon strings or metal wires supporting the ends of each compression member but also thin films formed over the entire surface of at least eight faces of the icosahedron may be used. In a second embodiment, an example in which a transmitting/receiving device is configured using thin films as tension members will be described. Note that in the following description, the description of the contents that overlap with the first embodiment will be omitted and the different portions will be described.

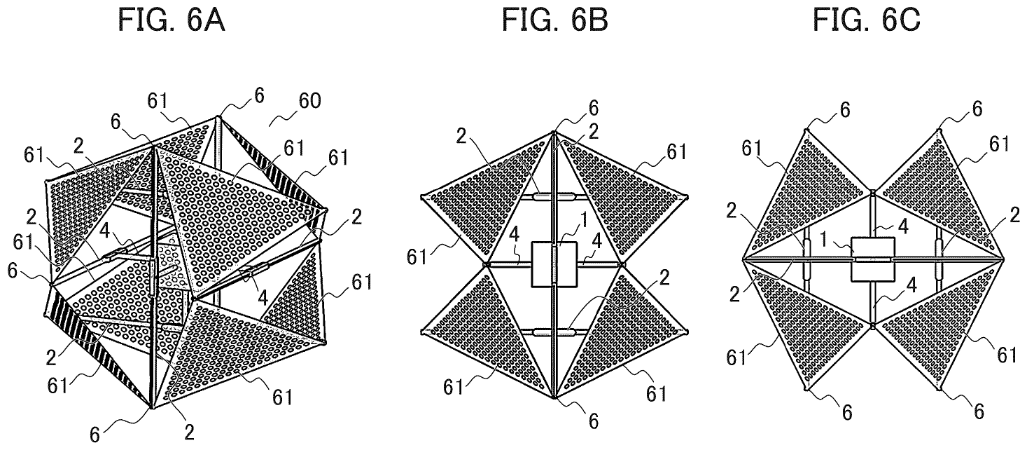

FIG. 6 illustrates an example of the configuration of an OAM radio wave transmitting/receiving device according to the second embodiment. FIGS. 6A, 6B, and 6C illustrate a bird's-eye view, front view, and side view, respectively. In FIG. 6, a transmitting/receiving device 60, as is the case with the transmitting/receiving device 10 illustrated in FIG. 1, includes the control device 1 located approximately in the center of the transmitting/receiving device 10, the plurality of compression members 2, a plurality of tension members 61, and the plurality of poles 4 connecting the control device 1 and each compression member 2, and forms a virtual regular icosahedral three-dimensional structure around the control device 1 using the compression members 2 and the tension members 61. The plurality of tension members 61 are constituted by thin films formed over the entire surface of at least eight faces of the icosahedron. Each edge of each triangular thin film supports the two nearest ends 6 among the total of twelve ends 6 of the compression members 2 by the tension of the thin film. As a result, each end 6 of each compression member 2 is simultaneously supported by two edges of the two thin films, and the compression force acting on the compression members 2 and the tension force by the thin films serving as the tension members 61 are balanced to form an icosahedron with a tensegrity structure around the control device 1.

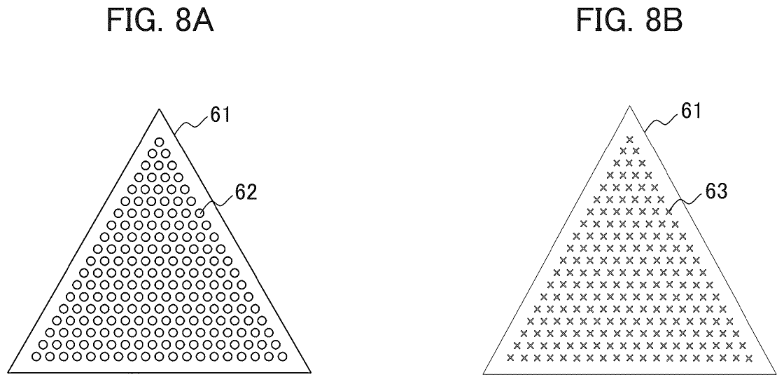

In the transmitting/receiving device 10 illustrated in FIG. 1, each compression member 2 functions as a dipole antenna. However, in the transmitting/receiving device 60 in FIG. 6, a plurality of patch antenna elements 62 are formed on each thin film, which serves as the tension member 61, and each thin film constitutes an array antenna. FIG. 8A illustrates an example of the configuration of one thin film (with the plurality of patch antenna elements 62 formed on the thin film). As illustrated in FIG. 8A, the thin film is formed with a number of the patch antenna elements 62 densely laid out. In the transmitting/receiving device 60, each tension member 61 thus functions as an array antenna. The various directional orientations and relative positional relationships of the tension members 61 enable the transmitting/receiving device 60 to also transmit and receive OAM radio waves in at least two directions without the need to rotate the device itself, or the like.

Other than what has been described above, the configuration of the control device 1 and the transmitting/receiving processing steps are all the same as those described in the first embodiment. However, as described above, in the transmitting/receiving device 60, since the plurality of patch antenna elements 62 are formed on each thin film, which serves as the tension member 61, and each tension member 61 functions as an array antenna, in S31 in FIGS. 3 and S41 in FIG. 4, the antenna selector 20 selects at least three array antennas from among at least eight array antennas (tension members 61). Alternatively, the antenna selector 20 may select at least three patch antenna elements 62 that are oriented at least two different directions among the plurality of patch antenna elements 62 formed on each tension member 61. In this case, any patch antenna elements 62 may be selected from among the plurality of patch antenna elements 62 formed on one tension member 61.

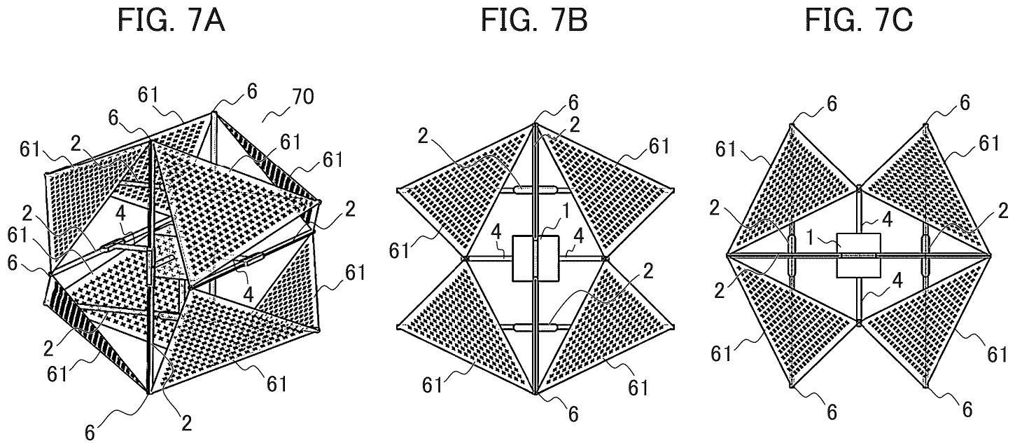

Next, a modification of the transmitting/receiving device according to the second embodiment will be described. FIG. 7 illustrates a modification of the OAM radio wave transmitting/receiving device according to the second embodiment. FIGS. 7A, 7B, and 7C illustrate a bird's-eye view, front view, and side view, respectively. Note that in the following description, the description of the contents that overlap with the transmitting/receiving device 60 illustrated in FIG. 6 will be omitted and the different portions will be described. In FIG. 7, a transmitting/receiving device 70 is configured similarly to the transmitting/receiving device 60 illustrated in FIG. 6, differing from the transmitting/receiving device 60 in that a plurality of cross-antenna elements 63 are formed (densely laid out) on each thin film, which is the tension member 61. FIG. 8B illustrates an example of the configuration of one thin film (with the plurality of cross-antenna elements 63 formed on the thin film). As illustrated in FIG. 8B, the thin film is formed with a number of the cross-antenna elements 63 densely laid out, so that each tension member 61 functions as an array antenna in the transmitting/receiving device 60. All other points are the same as those of the transmitting/receiving device 60 described above.

As described above, in addition to the similar effect to that in the first embodiment, the transmitting/receiving device according to the second embodiment is capable of transmitting and receiving OAM radio waves in at least two directions by selecting any antenna from among more array antennas or antenna elements than the dipole antennas in the first embodiment.

### Third Embodiment

In the second embodiment, an example has been described in which a thin film is used as a tension member and furthermore, a plurality of patch antenna elements or cross-antenna elements are formed on the thin film to configure each tension member as an array antenna. However, by forming multiple loop antennas with the tension members, the tension members can also function as a loop antenna array. In a third embodiment, an example in which the tension members function as a loop antenna array in this manner will be described. Note that in the following description, the description of the contents that overlap with the first and second embodiments will be omitted and the different portions will be described.

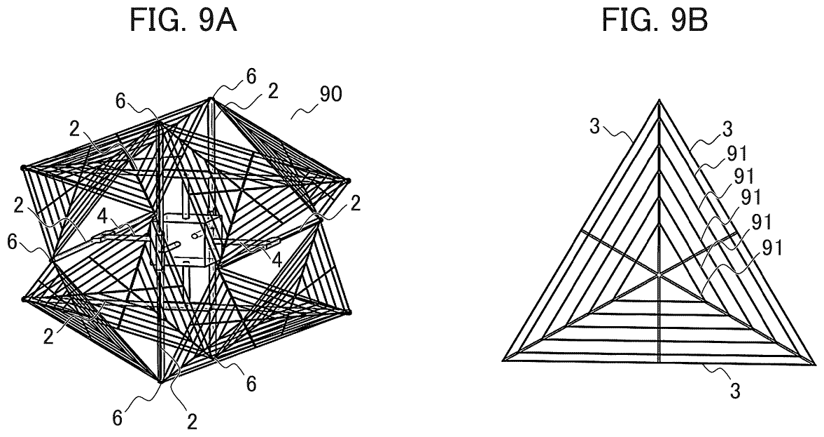

FIG. 9 illustrates an example of the configuration of an OAM radio wave transmitting/receiving device according to the third embodiment. FIG. 9A illustrates a bird's-eye view, and FIG. 9B illustrates an example of a loop antenna array formed by tension members on one face of an icosahedron. In FIG. 9A, a transmitting/receiving device 90 is configured similarly to the transmitting/receiving device 10 illustrated in FIG. 1, and uses the plurality of compression members 2 and the plurality of tension members 3 to form a virtual regular icosahedral three-dimensional structure around the control device 1. On at least eight faces of this icosahedron, multiple concentric triangular loops are formed by tension members made of the similar material to the tension members 3, inside the triangle surrounded by the three tension members 3, as illustrated in FIG. 9B. Each of the triangular loops serves as a loop antenna, so that the plane on which triangular loop antennas 91 are formed in multiple layers functions as a loop antenna array as a whole plane. The various directional orientations and relative positional relationships of the loop antenna arrays composed of the tension members enable the transmitting/receiving device 90 to also transmit and receive OAM radio waves in at least two directions without the need to rotate the device itself, or the like.

Other than what has been described above, the configuration of the control device 1 and the transmitting/receiving processing steps are all the same as those described in the first embodiment. However, as described above, in the transmitting/receiving device 90, the multiple loop antennas 91 are formed on each of at least eight faces of the icosahedron by the tension members to constitute a loop antenna array, and, by setting the circumference length of the loop to x l time the wavelength, an lth order OAM radio wave is generated (where l is an integer). In S31 in FIGS. 3 and S41 in FIG. 4, the antenna selector 20 selects at least two loop antenna arrays from among at least eight loop antenna arrays. Alternatively, the antenna selector 20 may select the loop antennas 91 that are oriented in at least two directions from among the plurality of loop antennas 91 formed by the tension members. In this case, any loop antennas 91 may be selected from among the plurality of loop antennas 91 that constitute a loop antenna array.

As described above, the transmitting/receiving device according to the third embodiment can achieve the similar effects to those in the first and second embodiments.

Although the embodiments and modification according to the present invention have been described above, the present invention is not limited to one of the above-described embodiments, but includes various modifications. For example, the above-described embodiments have been described in detail in order to facilitate the understanding of the present invention, and the present invention is not limited to those including all the configurations described here. In addition, part of the configuration of one example of an embodiment can be replaced with the configuration of another example. Further, the configuration of one example of an embodiment can also be added with the configuration of another example. In addition, part of the configuration of one example of each embodiment may be added to, deleted from, or replaced with other configurations. In addition, each of the above-mentioned configurations, functions, processing units, processing sections, and the like may be implemented in hardware, for example, by designing some or all of them in an integrated circuit. In addition, the control and information lines in the drawings are those that are considered necessary for illustrative purposes and not all of them are shown. Almost all configurations may be considered to be interconnected.

What is claimed is:

1. An electromagnetic wave transmitting/receiving device comprising:
a plurality of antennas;
a plurality of phase shifters each connected to a corresponding one of the plurality of antennas; and
a phase shift controller that controls phase-shifting by the plurality of phase shifters, wherein
the phase shift controller identifies phases of the plurality of phase shifters connected to three or more antennas oriented in at least two different directions, with respect to an approximate center of the three or more antennas on the basis of directional orientations and relative positions of the three or more antennas, and controls the plurality of phase shifters connected to the three or more antennas.

2. The electromagnetic wave transmitting/receiving device according to claim 1, further comprising
an antenna selector that selects an antenna to be used for transmitting or receiving electromagnetic waves from among the plurality of antennas, wherein
the antenna selector selects three or more antennas oriented in at least two different directions from among the plurality of antennas in accordance with directions in which the electromagnetic waves are transmitted or received, and
the phase shift controller identifies phases of the plurality of phase shifters connected to the three or more antennas selected by the antenna selector, with respect to an approximate center of the three or more antennas on the basis of directional orientations and relative positions of the three or more antennas, and controls the plurality of phase shifters connected to the three or more antennas.

3. The electromagnetic wave transmitting/receiving device according to claim 1, wherein
the electromagnetic waves to be transmitted or received are electromagnetic waves with orbital angular momentum (OAM), and
the phase shift controller calculates the phase of each of the plurality of phase shifters connected to the three or more antennas, on the basis of an OAM mode, the number of the three or more antennas, and the phase dependent on the directional orientation and relative position of each of the three or more antennas.

4. The electromagnetic wave transmitting/receiving device according to claim 1, further comprising
a signal formation unit that generates a signal to be transmitted from the three or more antennas, wherein
each of the phase shifters connected to the three or more antennas changes a phase of the signal to be transmitted to the phase identified by the phase shift controller and outputs the phase-shifted signal.

5. The electromagnetic wave transmitting/receiving device according to claim 4, further comprising
a distributor/combiner that distributes the signal generated by the signal formation unit to each of the three or more antennas and combines the signals received by the three or more antennas.

6. The electromagnetic wave transmitting/receiving device according to claim 1, further comprising
an attitude controller that adjusts directions of the three or more antennas in accordance with directions in which electromagnetic waves are transmitted or received.

7. A method for transmitting and receiving electromagnetic waves using a plurality of antennas, the method comprising:
selecting three or more antennas oriented in at least two different directions from among the plurality of antennas in accordance with directions in which the electromagnetic waves are transmitted or received; and
identifying phases of the plurality of phase shifters each connected to a corresponding one of the selected three or more antennas, with respect to an approximate center of the three or more antennas on the basis of directional orientations and relative positions of the selected three or more antennas, and controlling the plurality of phase shifters.

8. The method according to claim 7, wherein
the electromagnetic waves to be transmitted or received are electromagnetic waves with orbital angular momentum (OAM), and
in identifying the phases, the phase of each of the electromagnetic waves transmitted or received from the three or more antennas is calculated on the basis of an OAM mode, the number of the three or more antennas, and the phase dependent on the directional orientation and relative position of each of the three or more antennas.

9. The method according to claim 7, further comprising:
generating a signal to be transmitted from the three or more antennas; and
changing a phase of the signal to be transmitted to the identified phase, and transmitting the phase-shifted signal.

10. The method according to claim 9, further comprising
distributing the generated signal to each of the three or more antennas.

11. The method according to claim 7, further comprising
adjusting the directions of the three or more antennas in accordance with the directions in which the electromagnetic waves are transmitted or received.

12. An electromagnetic wave transmitting/receiving device comprising:
a plurality of compression members of equal length, two for each of three rotational symmetry axes orthogonal to each other at an approximate center of the electromagnetic wave transmitting/receiving device, the two compression members being arranged equidistant from the rotational symmetry axis with the rotational symmetry axis sandwiched between the two compression members, and parallel to each other;
a plurality of tension members each connecting two nearest ends of the plurality of compression members; and
a control device located approximately in the center of the electromagnetic wave transmitting/receiving device and connected to each of the plurality of compression members, wherein
each of the plurality of compression members functions as a dipole antenna, and
the control device selects three or more compression members oriented in at least two different directions from among the plurality of compression members and transmits and receives electromagnetic waves using the three or more compression members.

13. The electromagnetic wave transmitting/receiving device according to claim 12, wherein
the control device controls a phase of each of the electromagnetic waves transmitted or received from the three or more compression members, such that the electromagnetic waves rotate with respect to an approximate center of the three or more compression members on the basis of directional orientations and relative positions of the three or more compression members.

14. The electromagnetic wave transmitting/receiving device according to claim 12, wherein
the plurality of compression members and the plurality of tension members form an icosahedron with a tensegrity structure.

15. The electromagnetic wave transmitting/receiving device according to claim 14, further comprising:
a plurality of thin films on a plurality of faces of the icosahedron; and
a plurality of antenna elements on each of the plurality of thin films, wherein
each of the plurality of thin films, instead of the plurality of compression members, functions as an array antenna.

16. The electromagnetic wave transmitting/receiving device according to claim 14, further comprising
a loop antenna array on a plurality of faces of the icosahedron, wherein
the electromagnetic waves are transmitted or received using a plurality of the loop antenna array instead of the plurality of compression members.
